(19) United States
(12) Patent Application Publication
(10) Pub. No.: US 2005/0036424 A1
(43) Pub. Date: Feb. 17, 2005

(54) METHOD FOR WRITING AN OPTICAL DISK WITH UNIFORM WRITE STRATEGY

(76) Inventor: Chia-Fong Yang, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/710,892

(22) Filed: Aug. 11, 2004

(30) Foreign Application Priority Data
Aug. 13, 2003 (TW) 092122251

(51) Int. Cl. G11B 7/00

(52) U.S. Cl. 369/59.12; 369/59.11; 369/116

(57) ABSTRACT

A method for burning an optical disk in an optical disk drive includes determining a final start delay time of a laser pulse used to write a pit in the optical disk; if a land previous to the pit is 3-periods long, setting the final start delay time of the pit to be larger than in the case that a land previous to the pit is not 3-periods long. The method further includes determining a final end delay time of a laser pulse used to write a pit written in the optical disk; if a land following the pit is 3-periods long, setting the final end delay time of the pit to be smaller than in the case that a land following the pit is not 3-period long.

### BACKGROUND OF INVENTION

1. Field of the Invention

The present invention relates to a method for writing an optical disk, and more specifically, to a method for writing an optical disk by setting a write strategy parameter.

2. Description of the Prior Art

When storing data onto an optical disk, such as CD or DVD, an optical disk drive converts data into a storage format of the optical disk via an encoder of the optical disk drive. Such a kind of storage format is generally a run-length limited (RLL) modulation, such as eight-to-fourteen modulation (EFM) waveform. EFM waveform represents data on the optical disk by using clocks of different time lengths. For example, in a CD every interval between a pulse and a pulse of clocks stored on the disk is 3 to 11 times the length of the EFM base frequency. The optical disk drive burns data onto the disk according to the EFM waveform. The optical disk produces a plurality of pits and lands of different lengths to represent the data wherein the length of these pits and lands correspond to the waveform of EFM base frequency. In practice, the optical disk drive converts the EFM base frequency into laser pulses for driving the pickup head by using a set of write strategy parameters. When writing the data (i.e. producing the pits), the laser pulse drives the pickup head to switch from bias power to write power, wherein a write strategy parameter defines the length of the laser pulses with different write strategies for different conditions.

Please refer to FIG. 1 showing a conventional write strategy parameter, and FIG. 2 showing a table of conventional write strategy parameters according to the prior art. An EFM base frequency waveform 10 shows a pit of a length of N periods (NT). Assume the resolution of one period [1T] is 2⁵ (which is equal to 32), L is the length of a laser pulse 12, NsF defines a final start delay time of the laser pulse 12, and NeF defines a final end delay time of the laser pulse 12. L can be calculated as follows:
L=32(N+2) NsF (64 NeF) formula (1)

Simplified from formula (1), L=32N NsF+NeF formula (2)

As the technology in disk burning progresses, higher speed disk burners such as 32X and 48X appear, meaning that the EFM base frequency becomes shorter and shorter. Under these higher speed conditions, the pickup head switches between write power and bias power at a faster rate so that the length of the pits and lands is accordingly influenced. The conventional write strategy parameter needs to be adjusted according to the burning speed and the type of the optical disk. For instance, as shown in FIG. 2, set the final start delay time NsF the laser pulses 12 in different EFM base frequencies as the same value and the final end delay time NeF as another same value, that is in this case, NsF=34 and NeF=29, and the length L of the laser pulses 12 in different periods can be obtained by formula (2). However, such kind of write strategy parameter settings cannot be applied on different burning speed, thus it should be adjusted according to different burning speed.

As described above, the faster the burning speed is, the shorter the length of the EFM base frequency is. An optical disk drive requires different write strategy parameters for different types of optical disks, and even for the same type of optical disk, it still requires different write strategy parameters for different burning speeds. In other words, even for the same type of optical disk manufactured by the same maker, the optical disk drive still requires different write strategy parameters for different burning speeds from 20X to 48X, which becomes very complicated. Moreover, there are various kinds of optical disks. Thus, it is a burden to a memory of the optical disk drive to store all those write strategy parameters corresponding to different conditions.

### SUMMARY OF INVENTION

It is therefore a primary objective of the present invention to provide a method for setting a write strategy parameter in order to solve the problems mentioned above.

Briefly summarized, a method for writing an optical disk using an optical disk drive includes determining a final start delay time of a laser pulse used by the optical disk drive to write a pit on the optical disk, the final start delay time of the laser pulse used to write the pit being determined as a first value when there is a 3-period land previous to the pit, the final start delay time of the laser pulse used to write the pit being determined as a second value, which is less than the first value, when there is a non-3-period land previous to the pit, and writing the pit according to the laser pulse of the optical disk drive.

The present invention further provides a method for writing an optical disk using an optical disk drive including determining a final start delay time of laser pulses used by the optical disk drive to write a plurality of pits on the optical disk; the final start delay time of a 3-period pit being less than the final start delay time of a non-3-period pit, when there are lands with the same period before the plurality of pits respectively; and writing the optical disk according to the settings of the laser pulse of the optical disk drive.

The present invention further provides a method for writing an optical disk using an optical disk drive including determining a final end delay time of a laser pulse used by the optical disk drive to write a pit on the optical disk; the final end delay time of the laser pulse used to write the pit being determined as a first value when there is a 3-period land following the pit; the final end delay time of the laser pulse used to write the pit being determined as a second value, which is larger than the first value, when there is a non-3-period land following the pit, and writing the pit according to the laser pulse of the optical disk drive.

The present invention further provides a method for writing an optical disk using an optical disk drive including determining a final end delay time of laser pulses used by the optical disk drive to write a plurality of pits on the optical disk; the final end delay time of a 3-period pit being greater than the final end delay time of a non-3-period pit, when there are lands with the same period after the plurality of pits respectively; and writing the optical disk according to the settings of the laser pulse used by the optical disk drive.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a conventional write strategy parameter.

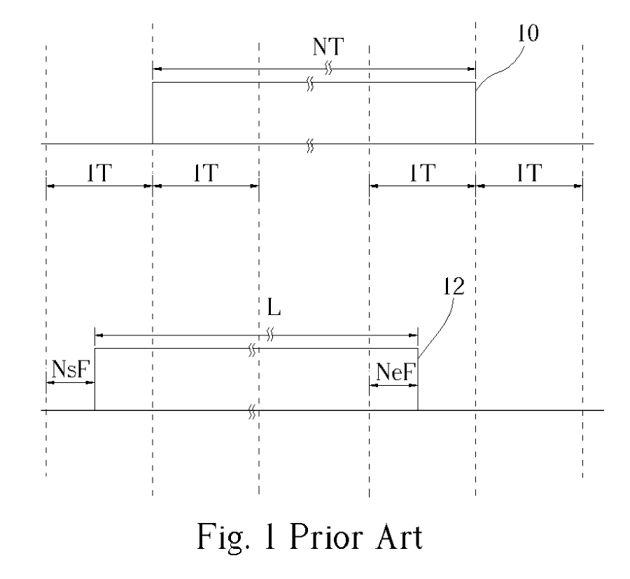

FIG. 2 is a table of conventional write strategy parameters according to the prior art.

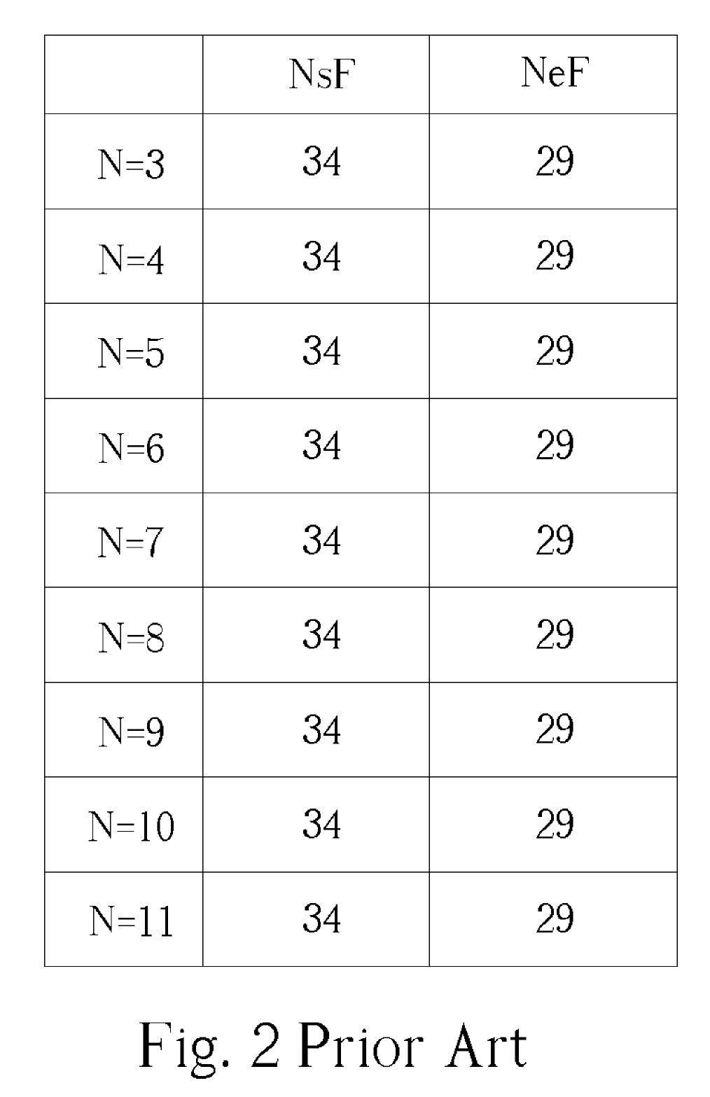

FIG. 3 illustrates a write strategy parameter according to the present invention.

FIG. 4 is a table of write strategy parameters according to the present invention.

FIG. 5 is a table of the final start delay times of the laser pulse according to the present invention.

FIG. 6 is a table of the final end delay times of the laser pulse according to the present invention.

### DETAILED DESCRIPTION

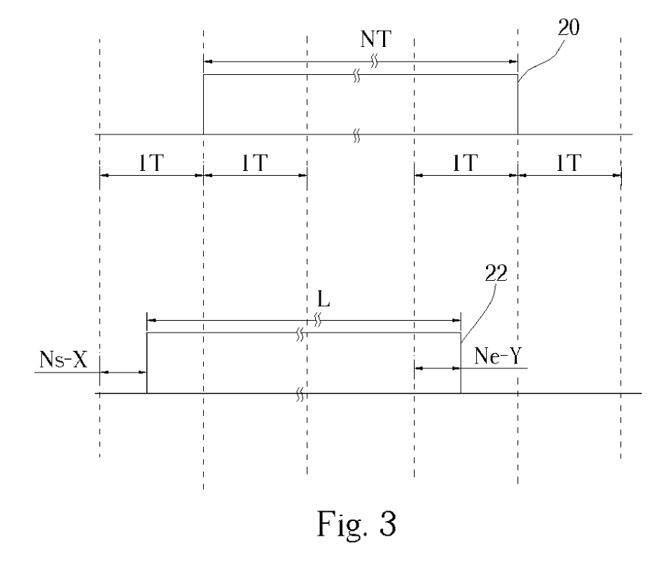

Please refer to FIG. 3 showing a write strategy parameter according to the present invention. According to the present invention, a final start delay time of a laser pulse 22 is determined by Ns and X, and a final end delay time of the laser pulse 22 is determined by Ne and Y. An EFM base frequency waveform 20 shows a pit of a length of N periods (NT). Assume the resolution of one period [1T] is 2⁵ (which is equal to 32), L is the length of a laser pulse 12, Ns is a final start delay time of the laser pulse 12, Ne is a final end delay time of the laser pulse 12, X is a complement determined according to the interval between the laser pulse 22 and a previous pulse (i.e. a land previous to the pit), Y is a complement determined according to the interval between the laser pulse 22 and a following pulse (i.e. a land following the pit). L can be calculated as follows:
L=32(N+2)(Ns X)[64 (Ne Y)] formula (3)
simplified from formula (3), L=32N (Ns X)+(Ne Y) formula (4)

Wherein (Ns X) defines the final start delay time of the laser pulse 22, and (Ne Y) defines the final end delay time of the laser pulse 22.

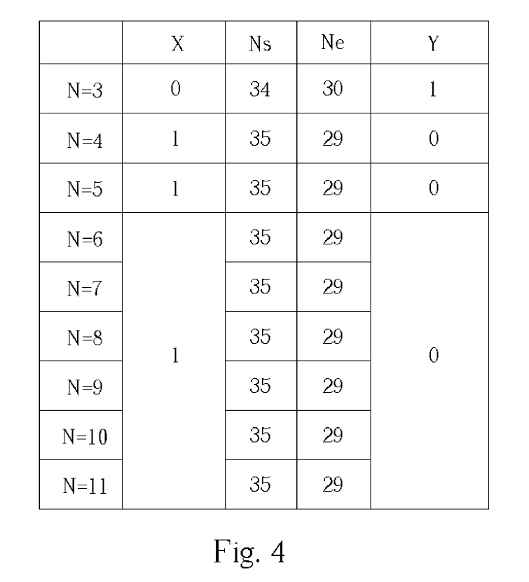

Please refer to FIG. 4 showing a table of the write strategy parameters according to the present invention. The present invention lengthens the length of 3-period pit and 3-period land in a relative manner by setting the write strategy parameters (i.e. final start delay time Ns, final start delay time complement X, final end delay time Ne, and final end delay time complement Y). The term “relative manner” means to lengthen the length of a 3-period pit when a 3-period pit is adjacent to a non-3-period (4-period to 11-period) land, or when a non-3-period pit is adjacent to a 3-period land; no action is taken when a 3-period pit is adjacent to a 3-period land or when a non-3-period pit is adjacent to a non-3-period land.

According to the present invention, there are two ways of lengthening the length of a 3-period pit. First, make the Ns of a 3-period pit less than the Ns of a non-3-period pit, and second, make the Ne of a 3-period pit larger than the Ne of a non-3-period pit. As for lengthening the length of a 3-period land, there are two ways. First, for any pit, make the X of the a 3-period land previous to the pit less than the X of the non-3-period land previous to the pit, and second, make the Y of the 3-period land following the pit less than the Y of the non-3-period land following the pit. In the present invention, the values of the final start delay time NS, final start delay time complement X, final end delay time Ne, and final end delay time complement Y are shown in the table in FIG. 4.

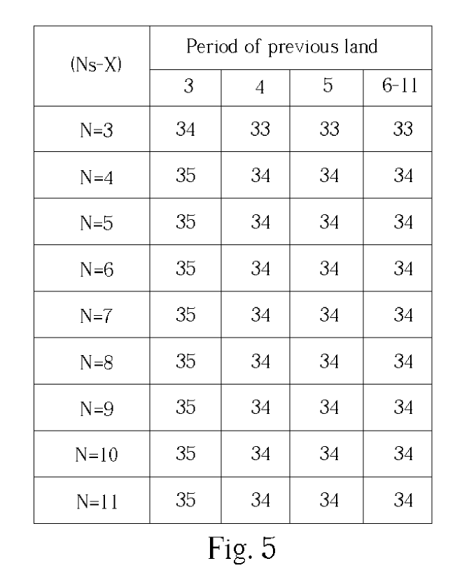

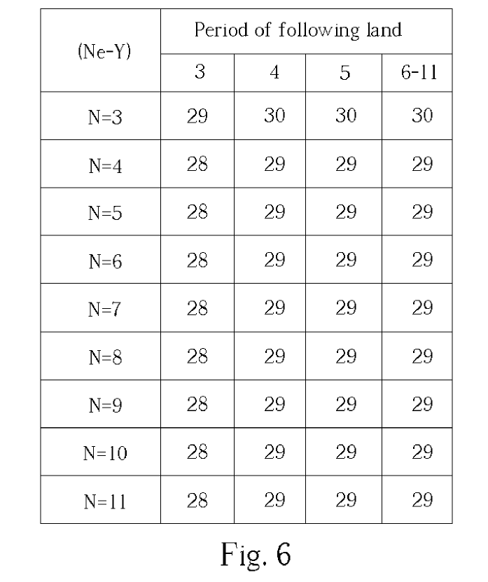

Please refer to FIG. 5 showing a table of the final start delay times of the laser pulse 22, and FIG. 6 showing a table of the final end delay times of the laser pulse 22 according to the present invention. The final start delay time of the laser pulse 22 is (Ns-X), and the final end delay time of the laser pulse 22 is (Ne-Y); thus the tables in FIG. 5 and FIG. 6 can be obtained according to the write strategy parameters in FIG. 4. According to the present invention, when determining the final start delay time of the laser pulse 22, there are two points that need to be mentioned. First, for pits with the same period, the final start delay time of the 3-period land previous to the pit is larger than the final start delay time of the non-3-period land previous to the pit. Second, for a pit having the same period as the land previous to it, the final start delay time of the 3-period land is less than the final start delay time of the non-3-period land. When determining the final end delay time of the laser pulse 22, there are also two points that need to be mentioned. First, for pits with the same period, the final end delay time of the 3-period land following the pit is less than the final end delay time of the non-3-period land following the pit. Second, for a pit having the same period as the land following it, the final end delay time of the 3-period land is larger than the final end delay time of the non-3-period land.

Please refer to FIG. 5 and FIG. 6. Assume that a 3-period pit with a 3-period land previous to it and a 3-period land following it is to be written; then (Ns X)=34 and (Ne Y)=29. From formula (4) we can know that the length of the 3-period pit [L] is equal to 91. Based on the length, if there is a 7-period land previous to the 3-period pit, (Ns X)=33, meaning that the laser pulse switches the pickup head to write power and lengthens the length of the 3-period pit [L] to 92. If there is a 7-period land following the 3-period pit, (Ne Y)=30 so that the laser pulse switches the pickup head to bias power and lengthens the length of the 3-period pit [L] to 92. Therefore, when a 3-period pit is adjacent to non-3-period lands, the length of the 3-period pit is lengthened.

Similarly, assume that a 7-period pit with a 6-period land previous to it and an 8-period land following it is to be written; then (Ns X)=34, (Ne Y)=29, and L=219. Based on the length, if there is a 3-period land previous to the 7-period pit, (Ns X)=35 so that the laser pulse switches the pickup head to write power and shortens the length of the 7-period pit [L] to 218. If there is a 3-period land following the 7-period pit, (Ne Y)=28 so that the laser pulse switches the pickup head to bias power and relatively lengthens the length of the 7-period pit [L] to 218. Therefore, when a non-3-period pit is adjacent to 3-period lands, the length of the 3-period land is lengthened.

As described above, the present invention determines a write strategy parameter to lengthen the 3-period pit, which of course accordingly lengthens the 3-period land. Since the pits and the lands exist alternately, the length of the pit and the length of the land influence each other. The present invention determines the write strategy parameter of the optical disk drive for a specific burning speed, and then applies the same write strategy parameter to higher burning speeds. According to related experiments, it can be successfully applied to optical disks of different types or made by different makers. Moreover, the block error rate (BLER) can be held to less than 20 blocks/sec.

In contrast to the prior art, the present invention determines the write strategy parameter used for various burning speeds so that one single type of optical disk made by the same maker requires only one write strategy parameter, and the modification of the write strategy parameter is simplified. For optical disks of the same type made by the same maker, according to the present invention, one needs only to change the write power of the pickup head in order to comply with high-speed burning with a very small BLER. Moreover, since the write strategy parameter is determined according to the present invention, calibration can be reduced, and also the time for adjusting the write strategy parameter can be reduced by using the same write strategy parameter for different burning speeds, and accordingly memory space for storing the write strategy parameter can be reduced. All of this is done while maintaining the BLER within a reasonable range when burning the same optical disk at different burning speeds.

Those skilled in the art will readily observe that numerous modifications and alterations of the method may be made while retaining the teachings of the invention. Accordingly, the above disclosure should be construed as limited only by the metes and bounds of the appended claims.

1. A method for writing an optical disk using an optical disk drive comprising:
determining a final start delay time of a laser pulse used by the optical disk drive to write a pit on the optical disk, the final start delay time of the laser pulse used to write the pit being determined as a first value when there is a 3-period land previous to the pit, the final start delay time of the laser pulse used to write the pit being determined as a second value, which is less than the first value, when there is a non-3-period land previous to the pit; and
writing the pit according to the laser pulse of the optical disk drive.

2. The method of claim 1 wherein the final start delay time comprises a start delay time and a start complement determined according to a land previous to the pit with the final start delay being the difference between the start delay time and the start complement.

3. The method of claim 2 further comprising:
determining the start delay time of the pit, the start delay time of the pit being determined as a third value when the pit is a 3-period pit, the start delay time of the pit being determined as a fourth value, which is larger than the third value, when the pit is a non-3-period pit.

4. The method of claim 2 further comprising:
determining the start complement of the pit, the start complement of the pit being determined as a fifth value when there is a 3-period land previous to the pit, the start complement of the pit being determined as a sixth value, which is larger than the fifth value, when there is a non-3-period pit previous to the pit.

5. The method of claim 1 wherein the non-3-period land is one of 4 to 11 periods lands.

6. The method of claim 3 wherein the non-3-period pit is one of 4 to 11 periods pits.

7. The method of claim 1 utilized as a write strategy parameter for a specific burning speed of the optical disk drive, and then applying the write strategy parameter to different burning speeds.

8. A method for writing an optical disk using an optical disk drive comprising:
determining a final start delay time of laser pulses used by the optical disk drive to write a plurality of pits on the optical disk, the final start delay time of a 3-period pit being less than the final start delay time of a non-3-period pit when there are lands with the same period before the plurality of pits respectively; and
writing the optical disk according to the settings of the laser pulse used by the optical disk drive.

9. The method of claim 8 wherein the final start delay time comprises a start delay time and a start complement determined according to a land previous to the pit with the final start delay being the difference between the start delay time and the start complement.

10. The method of claim 9 further comprising:
determining a start delay time of the pit, the start delay time of the pit being determined as a first value when the pit is a 3-period pit, the start delay time of the pit being determined as a second value larger than the first value when the pit is a non-3-period pit.

11. The method of claim 9 further comprising:
determining a start complement of the pit, the start complement of the pit being determined as a third value when there is a 3-period land previous to the pit, the start complement of the pit being determined as a fourth value larger than the third value when there is a non-3-period pit previous to the pit.

12. The method of claim 8 wherein the non-3-period land is 4 to 11 periods.

13. The method of claim 11 wherein the non-3-period pit is 4 to 11 periods.

14. The method of claim 8 utilizing a write strategy parameter for a specific burning speed of the optical disk drive and then applying the write strategy parameter to different burning speeds.

15. A method for writing an optical disk using an optical disk drive comprising:
determining a final end delay time of a laser pulse used by the optical disk drive to write a pit on the optical disk, the final end delay time of the laser pulse of the pit being determined as a first value when there is a 3-period land following the pit, the final end delay time of the laser pulse of the pit being determined as a second value larger than the first value when there is a non-3-period land following the pit; and
writing the pit according to the laser pulse of the pit used by the optical disk drive.

16. The method of claim 15 wherein the final end delay time comprises an end delay time and an end complement determined according to a land following the pit with the final end delay being the difference between the end delay time and the end complement.

17. The method of claim 16 further comprising:
determining the end delay time of the pit, the end delay time of the pit being determined as a third value when the pit is a 3-period pit, the end delay time of the pit being determined as a fourth value less than the third value when the pit is a non-3-period pit.

18. The method of claim 16 further comprising:
determining the end complement of the pit, the end complement of the pit being determined as a fifth value when there is a 3-period land following the pit, the end complement of the pit being determined as a sixth value less than the fifth value when there is a non-3-period pit following the pit.

19. The method of claim 15 wherein the non-3-period land is one of 4 to 11 periods lands.

20. The method of claim 17 wherein the non-3-period pit is one of 4 to 11 periods pits.

21. The method of claim 15 utilized as a write strategy parameter for a specific burning speed of the optical disk drive and then applying the write strategy parameter in different burning speeds.

22. A method for writing an optical disk by using an optical disk drive comprising:
determining a final end delay time of laser pulses by using the optical disk drive to write a plurality of pits on the optical disk, the final end delay time of a 3-period pit being greater than the final end delay time of a non-3-period pit when there are lands with the same period after the plurality of pits respectively; and
writing the optical disk according to the settings of the laser pulse used by the optical disk drive.

23. The method of claim 22 wherein the final end delay time comprises an end delay time and an end complement determined according to a land following the pit with the final end delay being the difference between the end delay time and the end complement.

24. The method of claim 23 further comprising:
determining an end delay time of the pit, the end delay time of the pit being determined as a first value when the pit is a 3-period pit, the end delay time of the pit being determined as a second value less than the first value when the pit is a non-3-period pit.

25. The method of claim 23 further comprising:
determining an end complement of the pit, the end complement of the pit being determined as a third value when there is a 3-period land following the pit, the end complement of the pit being determined as a fourth value less than the third value when there is a non-3-period pit following the pit.

26. The method of claim 22 wherein the non-3-period land is 4 to 11 periods.

27. The method of claim 25 wherein the non-3-period pit is 4 to 11 periods.

28. The method of claim 22 utilizing a write strategy parameter for a specific burning speed of the optical disk drive and then applying the write strategy parameter to different burning speeds.
